(19) United States
(12) Patent Application Publication
(10) Pub. No.: US 2026/0121951 A1
(43) Pub. Date: Apr. 30, 2026

(54) SYSTEMS AND METHODS FOR AUTOMATIC MAPPING OF APPLICATION COMPONENT DEPENDENCIES USING LOG ANALYSIS

(71) Applicant: BANK OF AMERICA CORPORATION, CHARLOTTE, NC (US)

(72) Inventors: John Andres Lozes, Wilmington, DE (US); Pramod Bhadravathi Srinivasa, Bear, DE (US); Asha Thekkumpurath, Frisco, TX (US); Manonmani Palanichamy, Fort Mill, SC (US); Amer Ali, Jersey City, NJ (US); Aravind Singtalur, McKinney, TX (US); Tonya Kyra Miller, Charlotte, NC (US); Mohammad Saleem Gaziani, Plano, TX (US); Aaron Gee, Palm Coast, FL (US); Andrea M. Weisberger, Jacksonville, FL (US); Naresh Kumar Petapalle, Greater London (GB); Aisha Jenkins, Atlanta, GA (US)

(73) Assignee: BANK OF AMERICA CORPORATION, CHARLOTTE, NC (US)

(21) Appl. No.: 18/930,519

(22) Filed: Oct. 29, 2024

(51) Int. Cl. H04L 43/045; G06F 8/41

(52) U.S. Cl. CPC H04L 43/045; G06F 8/433

(57) ABSTRACT

Systems, computer program products, and methods are described herein for automatic mapping of application component dependencies using log analysis. The present disclosure is configured to collect connectivity data from various sources, including log files, service logs, and network packet captures, to automatically identify relationships between applications. The system analyzes the collected data to determine communication protocols, interaction types, and data exchange volumes between the applications. Unique application identifiers are extracted to associate each communication with the correct application. The system persists the determined dependencies and associated metadata in a storage device, and generates visual maps of application relationships for user display. The system is further capable of producing on-demand reports based on user-defined parameters, such as relationship depth and specific communication paths. This automatic mapping process improves the accuracy and efficiency of tracking application dependencies, reducing the need for manual input and providing real-time insights for system management.

### TECHNOLOGICAL FIELD

Example embodiments of the present disclosure relate to automatic mapping of application component dependencies using log analysis.

### BACKGROUND

In modern application ecosystems, tracking and managing the relationships between software applications and their underlying system components is a critical task, especially in large-scale environments where numerous applications interact with each other. These relationships, or dependencies, can change frequently as systems evolve, making it difficult for administrators and developers to maintain accurate documentation. Traditionally, the mapping of these dependencies has been a manual process, relying on monitoring tools, manual inspection, or basic system logs, all of which may not provide complete or up-to-date information. This manual approach introduces inefficiencies and inaccuracies, especially when fixing or planning releases that depend on accurate dependency data. Current solutions also often fail to provide detailed information on the type, volume, and path of the communication between components, leaving gaps in the overall understanding of the system architecture.

Applicant has identified a number of deficiencies and problems associated with automatic mapping of application component dependencies using log analysis. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automatic mapping of application component dependencies using log analysis.

Embodiments of the present disclosure provide systems, methods, and computer program products for the automatic mapping of application component dependencies using log analysis. The invention leverages various types of application-generated artifacts, including web access logs, service logs, and network traffic captures, to automatically infer relationships between system components. These relationships may include protocol types (e.g., HTTP, Kafka, WebSocket), transaction volume over time, and specific identifiers such as pathnames or queue names. By automating this process, the system provides continuous and real-time updates to the mapping of dependencies, significantly reducing manual effort and increasing the accuracy of dependency tracking. The system further enables users to generate reports that reflect current dependency states based on various parameters, such as application name, depth of dependency, or service path information, thereby enhancing fix and release management efforts.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatic mapping of application component dependencies using log analysis, in accordance with an embodiment of the disclosure;

FIG. 2 illustrates a process flow for automatic mapping of application component dependencies using log analysis, in accordance with an embodiment of the disclosure; and

FIG. 3 illustrates a process flow for automatic mapping of application component dependencies using log analysis, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “connectivity data” refers to any form of data that reveals the communication patterns, interactions, or exchanges between different applications, services, or system components within a network. Connectivity data can be collected from logs (e.g., web access logs, service logs), network traffic captures, application event traces, and other system artifacts that record the flow of information between entities. This data provides insights into which components communicate, the frequency of communication, the protocols involved, and the volume of data exchanged. Connectivity data is typically collected continuously or periodically to reflect the current and dynamic state of the system.

An “application identifier” is any unique attribute, name, or tag that allows the system to differentiate one application from another. Such identifiers may include domain names, IP addresses, URLs, service names, or specific API paths. In distributed systems where multiple applications or services interact, application identifiers are essential for associating specific log entries or data packets with the corresponding application. These identifiers are extracted from connectivity data to track and analyze the relationships between different applications and components in the network.

“Log analysis” refers to the process of systematically parsing, inspecting, and interpreting logs generated by applications, servers, or network devices to derive meaningful information about system behavior. Logs may include detailed records of user requests, error messages, data transfers, and interactions between system components. The log analysis process often involves using parsers, pattern matching, or even machine learning algorithms to extract key metrics (e.g., response times, error rates) and infer relationships between applications. Tools such as ELK Stack, Splunk, or custom scripts may be used to analyze large volumes of logs.

A “packet capture” refers to the process of intercepting and storing data packets as they traverse a network. Packet captures provide granular information about the communication between applications and can include details such as source and destination IP addresses, ports, protocol types, and data payloads. Packet capture tools, such as Wireshark or tcpdump, are used to monitor network traffic in real-time, and the captured data can be analyzed to identify patterns, detect anomalies, or fix communication issues between applications. The captured packets are crucial for determining the type and volume of communication between applications.

A “service log” is a record or file generated by an application or service that logs key events, activities, or errors that occur during its operation. Service logs may include information on requests handled by the service, database transactions, user sessions, and system performance metrics. These logs are used for debugging, monitoring, and optimizing application performance. In the context of this invention, service logs are a key source of connectivity data, as they provide details about the interactions between services and other system components.

As used herein, “protocol” refers to the rules and standards that govern communication between applications or services. Examples of protocols include Hypertext Transfer Protocol (HTTP), File Transfer Protocol (FTP), WebSocket, Kafka, and JDBC. The protocol used for communication determines the format of messages exchanged, the sequence of operations, and error-handling mechanisms. Protocols are essential for enabling interoperability between different systems, and the system disclosed herein analyzes these protocols to determine the nature of relationships between applications.

A “connectivity relationship” describes the interaction or communication link between two or more applications or services within a networked system. This relationship includes details such as the protocols used (e.g., HTTP, WebSocket), the volume of data transferred, the frequency of interactions, and the direction of data flow. Connectivity relationships are critical for understanding how applications depend on each other to function within the system and for identifying bottlenecks or potential points of failure.

As used herein, “volume of data” refers to the amount of data exchanged between applications or services over a specific period of time. The volume of data can be measured in bytes, packets, or other appropriate units. By assessing the volume of data exchanged, the system can determine the intensity and load of communication between different applications. Volume data is particularly useful for identifying high-traffic relationships and for optimizing resource allocation in networked systems.

A “dependency map” is a graphical or structured representation of the relationships between various applications and system components. The map shows which applications communicate with each other, the paths through which data flows, and the dependencies between different components. In some embodiments, the dependency map is generated and updated automatically as new connectivity data is collected. The map may also highlight critical dependencies that, if broken, could disrupt the operation of the system.

As used herein, “persist” refers to the action of storing data or information in a manner that ensures its availability for future use. In the context of this invention, persistence refers to saving connectivity relationships and metadata (such as protocols and data volumes) in a database or other storage medium. Data may be persisted in a relational database, NoSQL database, or graph database, depending on the structure of the information being stored. This stored data can be accessed later for reporting, fixing, or auditing purposes.

An “on-demand report” is a dynamically generated document or visualization that provides information about application dependencies based on specific user input or query parameters. Users may request reports to show specific applications, relationship depths, or data flows, and the system generates the report in real-time using stored connectivity data. These reports are valuable for fixing, optimizing performance, and ensuring that applications interact correctly within the network.

As used herein, a “sample period” is the specific duration of time over which data is collected from applications or services. This time period may be predefined or dynamically adjusted based on system activity or user settings. During the sample period, data such as logs, service events, and network traffic are gathered to provide an accurate snapshot of system behavior and application interactions. Sample periods are used to ensure that the system continuously updates its understanding of connectivity relationships.

A “graph database” is a type of database designed to store and represent data in terms of nodes (entities) and edges (relationships between entities). In this disclosure, a graph database is used to store connectivity relationships between applications, where each node represents an application and each edge represents a communication link between them. Graph databases like Neo4j are ideal for modeling complex, interconnected systems such as application ecosystems.

As used herein, “regular expression” (regex) refers to a sequence of characters that defines a search pattern for string matching within text, such as log entries. In the context of this invention, regular expressions may be used to extract application identifiers, protocols, or other relevant information from logs or packet captures. Regex patterns are an efficient way to automate the process of identifying relevant data within large volumes of text.

A “machine learning model” refers to an algorithmic system trained on historical data to make predictions, classifications, or decisions without explicit programming. In some embodiments, machine learning models may be used to classify application relationships, detect anomalous patterns in connectivity data, or predict future interactions between applications. These models can be trained using supervised, unsupervised, or reinforcement learning techniques, depending on the data available.

As used herein, a “visualization tool” refers to any software library or platform used to create graphical representations of data. Examples include D3.js for interactive data visualizations, Graphviz for creating directed graphs, and Kibana for visualizing log and time-series data. In this invention, visualization tools are used to generate maps or charts that represent application dependencies and connectivity relationships, helping users easily interpret complex data.

A “time-series database” refers to a specialized database optimized for storing time-stamped data. Time-series databases, such as InfluxDB, are commonly used to store metrics that change over time, like network traffic volumes or application request rates. In the context of this invention, a time-series database may be used to store historical records of connectivity data, allowing users to track how application relationships evolve over time.

An “API” (Application Programming Interface) is a set of functions and protocols that allows one software application to interact with another. In the context of this invention, APIs may be used to access logs, query the stored connectivity data, or generate on-demand reports. The API allows the system to be integrated with other software tools, such as monitoring platforms or performance dashboards, to extend its functionality.

As used herein, a “scheduler” is a software tool or service that automates the execution of tasks at specified intervals or in response to events. In some embodiments, a scheduler like cron or Celery may be used to trigger periodic data collection, ensuring that the system continuously monitors application interactions and updates the dependency map. The scheduler can also handle maintenance tasks such as data cleanup or report generation.

An “event-driven architecture” refers to a system design in which components respond to events or triggers rather than running in continuous loops. In the context of this invention, an event-driven architecture may be used to detect changes in connectivity relationships, such as new application deployments or changes in data flow, and trigger updates to the dependency map or reports. This architecture ensures that the system stays up to date with minimal latency.

The technology described in the present disclosure relates to systems and methods for automatically mapping application component dependencies using log analysis. The system leverages existing application artifacts, such as web access logs, service logs, and network traffic captures, to automatically determine the relationships between applications and system components. These relationships may include key details like communication protocols, volume of data transferred, and specific identifiers (e.g., HTTP paths or database query names), enabling a more accurate and automated understanding of the dependencies within complex systems.

In large-scale distributed systems, accurately documenting and understanding the relationships and dependencies between various application components is a significant challenge. As applications grow and evolve, the manual process of tracking these dependencies becomes increasingly inefficient and error-prone. Additionally, current tools often fail to capture important aspects of these dependencies, such as the volume of data exchanged, the type of communication protocol used, or the specific system components involved. This lack of accurate, real-time information complicates optimization, system updates, and release management, as incomplete or outdated data can lead to system inefficiencies, errors, or even outages.

The solution provided by this technology automates the process of identifying and mapping how different software applications are connected within a system. By analyzing logs that applications already generate, the system can automatically discover which applications interact with each other, how they communicate, and how much data is exchanged between them. This removes the need for manual effort, continuously keeps the dependency information up to date, and provides more accurate insights, making it easier for developers and administrators to understand, optimize, and manage complex systems.

Accordingly, the present disclosure provides systems, methods, and computer program products that automatically generate and update application component dependencies by analyzing various types of logs and network data. The technology identifies relationships between applications, such as the type and protocol of communication, volume of data transferred, and specific identifiers like HTTP paths or service names. It collects connectivity information from web access logs, service logs, network traffic, and other application-generated artifacts. The system processes this data to determine the relationships between applications, allowing for accurate and real-time documentation of dependencies, which can be used for optimization, system upgrades, release planning, and other management tasks.

What is more, the present disclosure provides a technical solution to a technical problem. As described herein, the technical problem includes the difficulty of accurately and efficiently documenting application dependencies in real-time without manual input, especially in large-scale, distributed systems. The technical solution presented herein allows for automated identification and mapping of these dependencies by leveraging existing log data and network traffic information generated by the applications themselves. In particular, this solution eliminates the need for manual documentation and constant monitoring by using automated analysis to identify and maintain up-to-date dependency maps. This is an improvement over existing solutions to the problem of application dependency tracking, (i) by reducing the number of manual steps required, thus conserving computing resources such as processing power and storage; (ii) by improving the accuracy of the dependency data, reducing the need for resource-intensive corrections; (iii) by removing the need for manual input, which enhances the speed and efficiency of the process and decreases the likelihood of human error; and (iv) by optimizing the amount of computing and network resources required to track dependencies, reducing unnecessary data traffic and system load. Furthermore, the technical solution described herein automates a process that was previously manual and time-consuming, providing a more efficient, reliable, and scalable approach to managing application dependencies in modern computing environments.

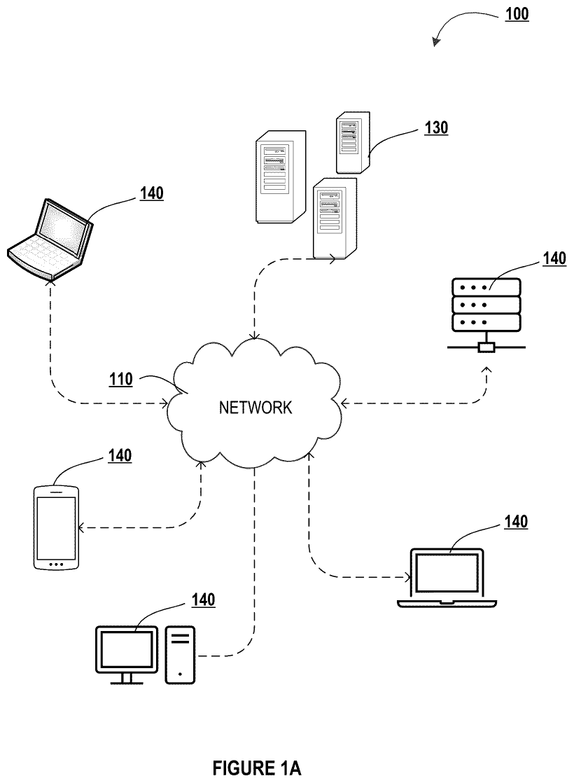

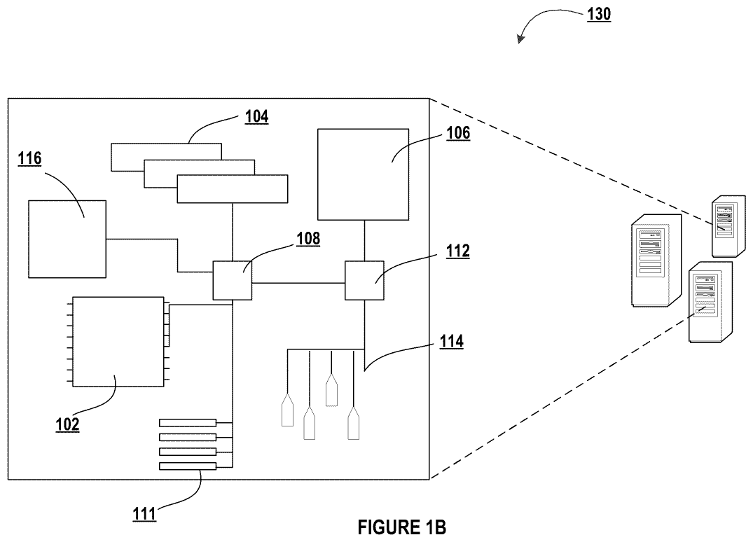

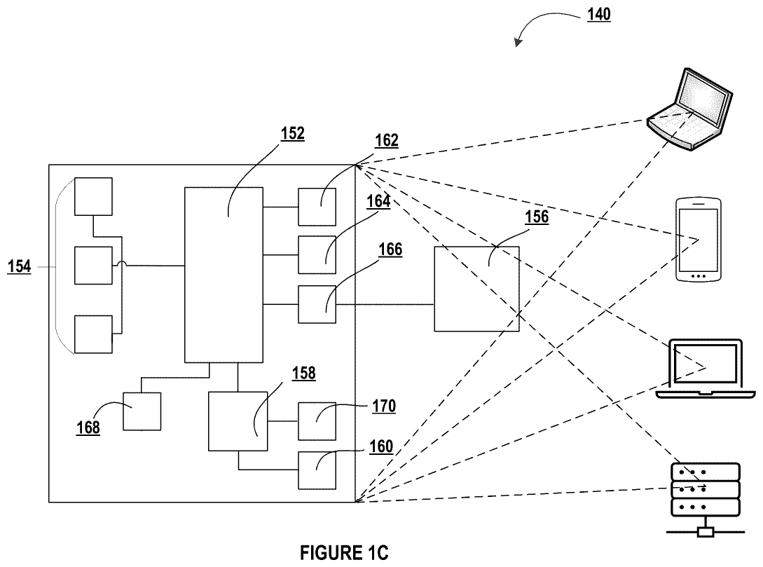

FIGS. 1A-1C illustrate technical components of an exemplary distributed computing environment 100 for automatic mapping of application component dependencies using log analysis, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

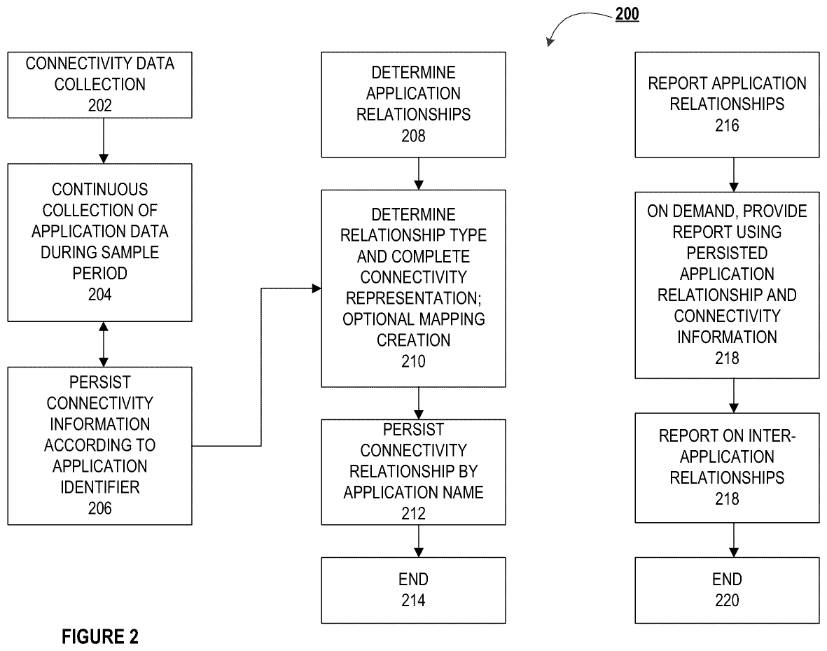

FIG. 2 illustrates a process flow for automatic mapping of application component dependencies using log analysis, in accordance with an embodiment of the disclosure. At block 202, the system begins by collecting connectivity information from various sources, such as web access logs, service logs, and network traffic captures. These sources provide a rich set of data that can be analyzed to infer relationships between applications and system components. The system continuously collects this data over a defined sample period to ensure that the connectivity relationships are current and reflective of the actual system state.

At block 204, the system performs continuous collection of application data throughout a specified sample period. This ongoing collection allows the system to capture the dynamic nature of the application dependencies, ensuring that the mapping reflects up-to-date relationships between applications, including any changes or new connections that occur during the sample window.

At block 206, the collected connectivity information is persisted using application identifiers, such as domain names or other unique identifiers. This ensures that the data is stored in a manner that associates specific applications with their respective connectivity details. The persistence of this data is crucial for accurate dependency mapping and for generating reports at later stages of the process.

At block 208, the system analyzes the persisted connectivity information to determine the relationships between different applications. These relationships may include the type of communication protocol (e.g., HTTP, WebSocket), the path or route of the communication, and the volume of data exchanged between the applications. By leveraging both sides of the communication exchange, the system creates a more complete and accurate picture of the dependency relationships.

At block 210, the system determines the types of relationships between the applications and completes a full connectivity representation. This involves identifying communication types, paths, and data volumes, as well as other relevant details. The system may also optionally generate a visual or structured map of the application dependencies, providing users with an easy-to-interpret representation of the relationships.

At block 212, the system persists the determined connectivity relationships by application name. This step ensures that the relationships between applications are stored and can be referenced or queried in the future. The persistence of this data allows the system to provide ongoing insight into how applications interact and depend on one another over time.

At block 214, this specific branch of the process ends after persisting the connectivity relationships. The system has now mapped and stored the application dependencies, allowing for further analysis or reporting as needed.

At block 216, the system prepares to report on the discovered application relationships. This step may be initiated on demand, depending on user input or specific system triggers. The reports are generated using the persisted connectivity and relationship information, providing users with detailed insights into the current state of application dependencies.

At block 218, when requested by the user, the system generates a report that reflects the persisted application relationships. The report may be customized based on specific parameters provided by the user, such as starting application, relationship depth, or service path details. This allows users to query and visualize specific parts of the application dependency map for optimization, release management, or other purposes.

At block 220, the system completes the reporting process by generating detailed reports on the relationships between applications. These reports can be used for various purposes, including system audits, debugging, and performance optimization, as they provide an accurate and up-to-date view of how applications interact within the system.

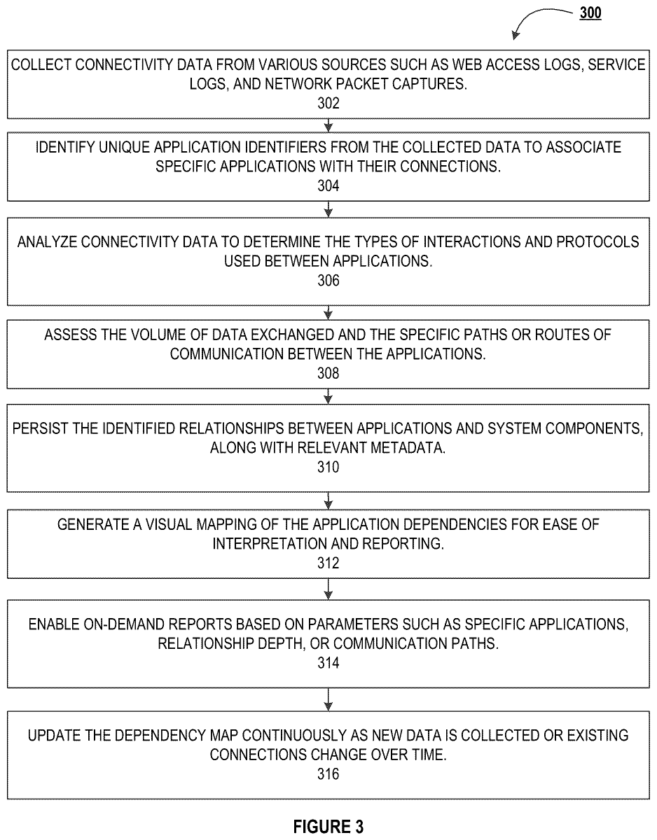

FIG. 3 illustrates a process flow for automatic mapping of application component dependencies using log analysis, in accordance with an embodiment of the disclosure. The process begins with the collection of connectivity data from multiple sources. These sources may include web access logs, service logs, network packet captures, and other system-generated artifacts. In some embodiments, the system can be implemented using a combination of software and hardware components, such as server-side log collectors that run on application servers. The log collectors may be programmed in languages such as Python, Java, or Go, and may utilize logging frameworks like Log4j, syslog, or similar. Additionally, network packet capture tools such as Wireshark or tcpdump can be used to capture traffic between application components. This data is typically stored in centralized databases, such as Elasticsearch or MongoDB, allowing the system to aggregate and analyze connectivity patterns across the entire application ecosystem. The system may also make use of APIs to extract log data from cloud platforms or third-party services.

Once the connectivity data is collected, the system parses the logs and packet captures to identify unique application identifiers, such as domain names, IP addresses, or service paths. In some embodiments, the system may use regular expressions, parsers, or machine learning algorithms to extract relevant identifiers from the raw data. For instance, the system could employ a Python script with regex patterns to search for known application names or identifiers in HTTP logs or database queries. The identified applications are then associated with their respective connectivity details, which may include information like request-response cycles, protocol types (e.g., HTTP, WebSocket, JDBC), and message queues. The system ensures that each application is linked with its communication endpoints to facilitate accurate mapping of the relationships between components.

After associating applications with their connectivity details, the system analyzes the data to determine the types of interactions between applications. This analysis involves detecting the protocols used for communication, such as HTTP, WebSocket, Kafka, or FTP, and identifying the paths along which data travels between components. In some embodiments, this analysis can be performed using pattern-matching algorithms or protocol analysis tools. For instance, a Java-based parser could be developed to recognize specific protocol headers in network traffic, or machine learning models could be trained to classify interactions based on log patterns. Additionally, tools like Snort or Suricata may be integrated to inspect network traffic and extract relevant protocol information. The system may store these interaction details in a relational database (e.g., PostgreSQL) or graph database (e.g., Neo4j) to enable further exploration of the application dependencies.

Once the types of interactions and protocols are determined, the system evaluates the volume of data exchanged between applications and the specific paths or routes along which this data travels. In some embodiments, the system may use packet sniffers or log analysis tools to quantify the amount of data transferred over a given period. For example, the system could employ Apache Kafka to track message sizes in a data pipeline or use packet capture statistics to measure data throughput between services. The system also identifies specific communication paths, such as URL paths, API endpoints, or database queries. These paths are tracked and documented to provide a detailed view of how data flows between application components. The system may store these results in a time-series database, such as InfluxDB, to allow for historical analysis of data volumes and communication patterns over time.

The identified relationships between applications and system components, along with relevant metadata such as data volumes, protocols, and paths, are persisted for long-term storage and reference. In some embodiments, the system may use a combination of relational and non-relational databases to store this information. For example, the metadata could be stored in a MySQL database, while the actual connectivity data may be persisted in a NoSQL database like MongoDB or Cassandra. The system may also encrypt sensitive metadata before storing it to ensure data privacy and security, using encryption standards such as AES-256. Additionally, the relationships between applications could be modeled as a graph, with nodes representing applications and edges representing connectivity relationships. In such cases, a graph database like Neo4j can be used to store and visualize these dependencies.

The system generates a visual representation of the application dependencies, allowing users to easily interpret the relationships between system components. In some embodiments, the visual map may be created using software libraries such as D3.js or Graphviz, which can generate interactive graphs or diagrams based on the stored connectivity data. The visualization may display nodes representing applications and lines or arrows indicating the data flows between them. The system may provide users with the ability to customize the map by filtering specific applications, protocols, or paths, and the map may be updated in real-time as new data is collected. In addition to graphical representations, the system may also generate textual reports that summarize the connectivity relationships, using tools such as JasperReports or Apache PDFBox to format and export the reports.

In some embodiments, users can request on-demand reports based on specific parameters, such as the starting application, relationship depth, or communication paths. The system may provide a user interface that allows users to input these parameters, using web technologies like React or Angular for the frontend and a RESTful API for backend processing. Upon receiving the request, the system queries the stored connectivity data to generate a report that matches the user's criteria. For example, users may request a report that shows all applications communicating with a specific service or one that visualizes all connections within two degrees of a particular component. The generated report may include both visual and textual elements, enabling users to quickly identify and assess the current state of application dependencies.

The system continuously updates the dependency map as new connectivity data is collected or existing connections change. In some embodiments, the system runs periodic data collection jobs using a scheduler like cron or Celery, ensuring that the connectivity data is always up to date. The system may employ event-driven architectures to trigger immediate updates when critical changes are detected, such as new application deployments or significant shifts in data volume. These updates are reflected in the visual maps and reports, providing users with a real-time view of the current application dependencies. In addition, the system may store historical versions of the dependency maps to allow users to review and analyze changes in application relationships over time.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatic mapping of application component dependencies using log analysis, the system comprising:
a processing device;
a non-transitory storage device containing instructions when executed by the processing device, causes the processing device to perform the steps of:
collecting connectivity data from one or more sources, the connectivity data comprising log files, network packet captures, and service logs describing a plurality of applications;
identifying, from the connectivity data, unique application identifiers associated with the plurality of applications;
analyzing the connectivity data to determine interaction types, protocols, and communication paths between the plurality of applications;
determining a volume of data exchanged between the plurality of applications and specific paths through which data is transferred;
storing one or more application dependencies and associated metadata in a storage device; and
generating, based on the one or more application dependencies, a visual mapping of the application component dependencies for display to a user.

2. The system of claim 1, wherein the system is further configured to: generate on-demand reports based on user-specified parameters, the parameters including a starting application, a relationship depth, and communication paths between applications.

3. The system of claim 1, wherein the connectivity data is collected continuously during a predefined sample period, allowing the system to dynamically update the mapping of application dependencies in real-time.

4. The system of claim 1, wherein the system is further configured to: store the connectivity data and application dependencies in a graph database, wherein nodes of the graph database represent applications and edges of the graph database represent the communication relationships between the applications.

5. The system of claim 1, wherein the visual mapping generated by the system includes visual indicators of data volume, protocol type, and communication frequency between the applications.

6. The system of claim 1, further comprising using encryption to secure persisted application dependencies and associated metadata in the storage device, ensuring data privacy and security.

7. The system of claim 1, wherein the step of analyzing the connectivity data further comprises: using pattern-matching algorithms to identify protocols, data paths, and communication types between the plurality of applications.

8. A computer program product for automatic mapping of application component dependencies using log analysis, the computer program product comprising a non-transitory computer-readable medium comprising code causing an apparatus to:
collect connectivity data from one or more sources, the connectivity data comprising log files, network packet captures, and service logs describing a plurality of applications;
identify, from the connectivity data, unique application identifiers associated with the plurality of applications;
analyze the connectivity data to determine interaction types, protocols, and communication paths between the plurality of applications;
determine a volume of data exchanged between the plurality of applications and specific paths through which data is transferred;
store one or more application dependencies and associated metadata in a storage device; and
generate, based on the one or more application dependencies, a visual mapping of the application component dependencies for display to a user.

9. The computer program product of claim 8, wherein the code further causes the apparatus to: generate on-demand reports based on user-specified parameters, the parameters including a starting application, a relationship depth, and communication paths between applications.

10. The computer program product of claim 8, wherein the connectivity data is collected continuously during a predefined sample period, allowing the system to dynamically update the mapping of application dependencies in real-time.

11. The computer program product of claim 8, wherein the code further causes the apparatus to: store the connectivity data and application dependencies in a graph database, wherein nodes of the graph database represent applications and edges of the graph database represent the communication relationships between the applications.

12. The computer program product of claim 8, wherein the visual mapping generated by the system includes visual indicators of data volume, protocol type, and communication frequency between the applications.

13. The computer program product of claim 8, further comprising using encryption to secure persisted application dependencies and associated metadata in the storage device, ensuring data privacy and security.

14. The computer program product of claim 8, wherein the step of analyzing the connectivity data further comprises: using pattern-matching algorithms to identify protocols, data paths, and communication types between the plurality of applications.

15. A method for automatic mapping of application component dependencies using log analysis, the method comprising:
collecting connectivity data from one or more sources, the connectivity data comprising log files, network packet captures, and service logs describing a plurality of applications;
identifying, from the connectivity data, unique application identifiers associated with the plurality of applications;
analyzing the connectivity data to determine interaction types, protocols, and communication paths between the plurality of applications;
determining a volume of data exchanged between the plurality of applications and specific paths through which data is transferred;
storing one or more application dependencies and associated metadata in a storage device; and
generating, based on the one or more application dependencies, a visual mapping of the application component dependencies for display to a user.

16. The method of claim 15, wherein the method further comprises: generating on-demand reports based on user-specified parameters, the parameters including a starting application, a relationship depth, and communication paths between applications.

17. The method of claim 15, wherein the connectivity data is collected continuously during a predefined sample period, allowing the system to dynamically update the mapping of application dependencies in real-time.

18. The method of claim 15, wherein the method further comprises: storing the connectivity data and application dependencies in a graph database, wherein nodes of the graph database represent applications and edges of the graph database represent the communication relationships between the applications.

19. The method of claim 15, wherein the visual mapping generated by the system includes visual indicators of data volume, protocol type, and communication frequency between the applications.

20. The method of claim 15, wherein the step of analyzing the connectivity data further comprises: using pattern-matching algorithms to identify protocols, data paths, and communication types between the plurality of applications.
